(19) United States
(12) Patent Application Publication
(10) Pub. No.: US 2012/0174805 A1
(43) Pub. Date: Jul. 12, 2012

(54) Method and System for Performing Hole-Plugging Process on Circuit Board

(75) Inventors: Wen Te Chen, Guangdong (CN); Yueh Ching Chen, Guangdong (CN); Chen Chen, Guangdong (CN)

(73) Assignees: ZHUHAI FOUNDER TECHNOLOGY MULTILAYER PCB CO., LTD. FUSHAN BRANCH, Zhuhai (CN); PEKING UNIVERSITY FOUNDER GROUP CO., LTD., Beijing (CN)

(21) Appl. No.: 13/383,978

(22) PCT Filed: Jul. 13, 2010
(86) PCT No.: PCT/CN2010/075121

§ 371 Date: Mar. 26, 2012

(30) Foreign Application Priority Data
Jul. 13, 2009 (CN) 200910088289.6

(51) Int. Cl. B41L 13/14

(52) U.S. Cl. 101/117; 101/129

(57) ABSTRACT

The present application discloses a method for performing a hole-plugging process on a circuit board. The method comprises: forming at least two locating holes on the circuit board; delivering the circuit board to a locating area of a hole-plugging screen printer, and adjusting a moving path of the circuit board in the locating area according to a locating device of the hole-plugging screen printer and the locating holes; and transporting the circuit board to a screen printing area of the hole plugging screen printer automatically according to the moving path, and adjusting a hole-plugging stencil of the hole-plugging screen printer to align an inking point of the hole-plugging stencil with a hole to be plugged on the circuit board, so as to plug ink dropped from the inking point of the hole-plugging stencil into the hole. The present application discloses a system for executing above method.

### TECHNICAL FIELD

The present application relates to a circuit board manufacturing technique, more particularly, to a method and system for a performing hole-plugging process on a circuit board.

### BACKGROUND

In the process of manufacturing circuit board, especially a high density interconnection (HDI), an inner buried hole usually needs to be plugged and grinded to be flat, so as to increase the wiring area of an external layer. A conventional method is to use resin hole-plugging ink to plug buried holes. FIG. 1 is a flow chart of perfonning a hole-plugging process on a HDI according to prior art. The process comprises following steps: applying resin hole-plugging ink on a plug hole stencil evenly (step S101); disposing a HDI on a single-platform or double-platform hole-plugging machine and aligning it with the plug hole stencil, then dropping the hole-plugging ink on the plug hole stencil into the hole needed to be plugged on the HDI (step S102); taking down the HDI from the hole-plugging machine and putting it into an oven for baking so as to cure the ink in the hole (step S103); and taking the HDI out of the oven for further vitrified grinding to grind off the ink protruding on the surface of the HDI, so as to flattening the surface of the HDI (step S104).

However, when performing a hole-plugging operation on a HDI by using above method, the hole-plugging step and baking step of the HDI need an operator's manual operations, which leads to low production efficiency. Especially in the process of dropping the ink into the hole performed on the hole-plugging machine, in order to perform the dropping accurately, an operator needs to observe the position of the hole manually, which leads to poor technological accuracy and low production efficiency.

### SUMMARY

According to an aspect of the present application, a method for performing a hole-plugging process on a circuit board is provided. Such method comprises: forming at least two locating holes on the circuit board; delivering the circuit board to a locating area of a hole-plugging screen printer, and adjusting a moving path of the circuit board in the locating area according to a locating device of the hole-plugging screen printer and the locating holes; and transporting the circuit board to a screen printing area of the hole-plugging screen printer automatically according to the moving path, and adjusting a hole-plugging stencil of the hole-plugging screen printer to align an inking point of the hole-plugging stencil with a hole to be plugged on the circuit board, so as to plug ink dropped from the inking point of the hole-plugging stencil into the hole.

According to another aspect of the present application, a system for performing a hole-plugging process on a circuit board is provided. Such system comprises: a hole-plugging screen printer comprising a transporting device, a platform, a locating device, an adjusting device and a hole-plugging stencil, wherein the platform is used to support the circuit board and comprises a locating area and a screen printing area, wherein the hole-plugging screen printer is provided for adjusting a moving path of a circuit board at the locating area by the adjusting device according to the locating device and at least two locating holes formed on the circuit board; and transporting the circuit board to the screen printing area by the transporting device according to the moving path, and adjusting the hole-plugging stencil by the adjusting device to align an inking point on the hole-plugging stencil with the hole to be plugged on the circuit board, so as to plug ink dropped from the inking point of the hole-plugging stencil into the hole.

### DRAWINGS

FIG. 1 is a flow chart of a conventional method for performing a hole-plugging process on a circuit board;

FIG. 2 is a flow chart of a method for performing a hole-plugging process on a circuit board according to an embodiment of the present application;

FIG. 3A is a schematic view showing drilling positions of locating holes on a circuit board according to an embodiment of the present application;

FIG. 3B is a schematic view showing the position of each area of a hole-plugging screen printer according to an embodiment of the present application;

FIG. 4 is a flow chart of a method for performing a hole-plugging process on a circuit board according to an embodiment of the present application;

FIG. 5 is a schematic block diagram of a system for performing a hole-plugging process on a circuit board according to an embodiment of the present application;

FIG. 6 is a schematic view showing the drilling positions of locating holes on a circuit board according to an embodiment of the present application; and

FIG. 7 is a schematic block diagram of a system for performing a hole-plugging process on a circuit board according to an embodiment of the present application.

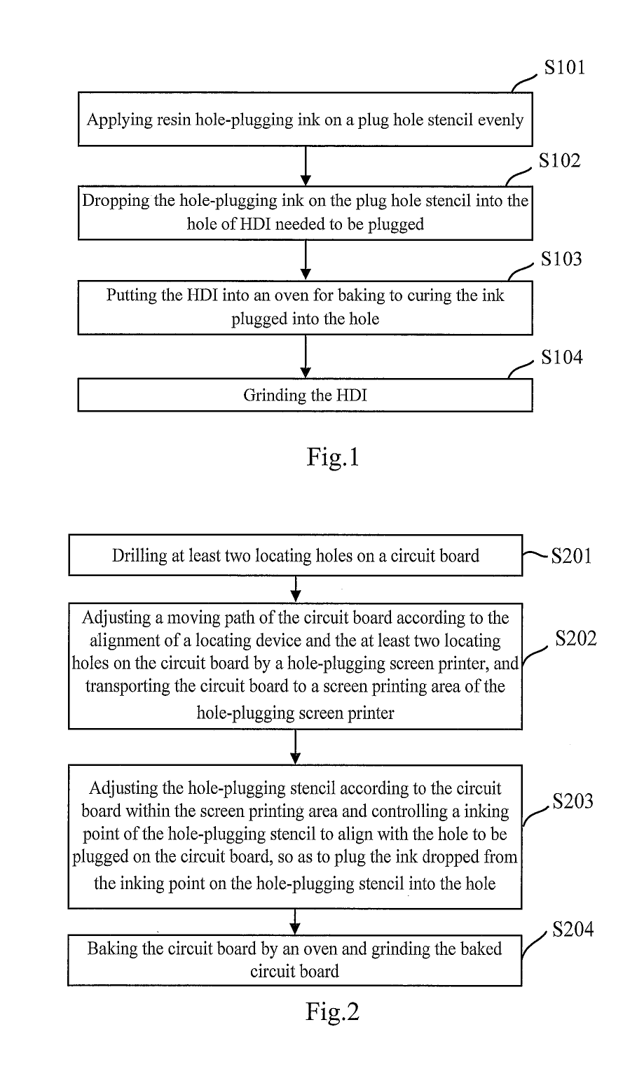

### DETAILED DESCRIPTION

The specific embodiments of the present application will be described in detail below by reference to the appended drawings.

FIG. 2 is a flow chart of a method for performing a hole-plugging process on a circuit board according to an embodiment of the present application. As shown in FIG. 2, the method comprises:

Firstly, forming at least two locating holes on a circuit board before performing a hole-plugging process on the circuit board (step S201);

Secondly, transporting the circuit board to a locating area on a platform of a hole-plugging screen printer, adjusting the moving path of the circuit board according to a locating device and the at least two locating holes drilled on the circuit board, and transporting the circuit board to a screen printing area on the platform of the hole-plugging screen printer along the adjusted moving path (step S202);

Next, adjusting the hole-plugging stencil within the screen printing area to align the inking point with the hole to be plugged on the circuit board, so as to let the ink dropped from the inking point on the hole-plugging stencil drop into the hole (step S203); and

Finally, unloading the hole-plugged circuit board after its baking process and grinding process are performed (step S204).

According to the present embodiment, an automatic hole-plugging process on a circuit board can be realized by automatically controlling the alignment of locating holes of the circuit board with the locating device, adjusting the moving path of the circuit board, and adjusting the position of the hole-plugging stencil according to the circuit board transported to a screen printing area of a hole-plugging screen printer. Comparing to manual operations, such method can increase not only the technological stability and consistency, but also the production efficiency in the hole-plugging process on a circuit board.

The embodiments of the present application will be further explained in detail below in combination with optional examples.

As mentioned above, the circuit board needs to be drilled at least two locating holes therein before being hole-plugged. According to an example of the application, the locating holes can be designed and drilled along with the buried holes. Additionally, the circuit board can be drilled by using a driller. When the circuit board is transported to a corresponding position of the driller, the driller will drill the locating holes on the circuit board according to set parameters. The parameters may comprise a number parameter, a size parameter and a position parameter of the locating holes. Generally, the number of the locating holes is two or more. The size parameter may comprise a diameter parameter and a radius parameter. The position parameter may be the distance from the locating hole to the length side and width side of the circuit board. As shown in FIG. 6, for example, the position parameter of a first locating hole may be the distance from the first locating hole to a first length side and the distance from the first locating hole to a first width side. The position parameter of a second locating hole may be the distance from the second locating hole to a second length side and the distance from the second locating hole to a second width side.

After being drilled with locating holes, the circuit board can be transported to a loading machine. The circuit board is then delivered to a locating area on a platform of a hole-plugging screen printer by the loading machine automatically. In the locating area, the hole-plugging screen printer aligns each of the at least two holes on the circuit board with a reference mark on the locating device by adjusting the position of the circuit board. By adjusting the position of the circuit board in the locating area, the moving path of the circuit board in its subsequent processes can be determined by such position, that is to say, the subsequent moving path of the circuit board is adjusted. The circuit board is automatically transported to the screen printing area of the hole-plugging screen printer along the adjusted moving path by a transporting device.

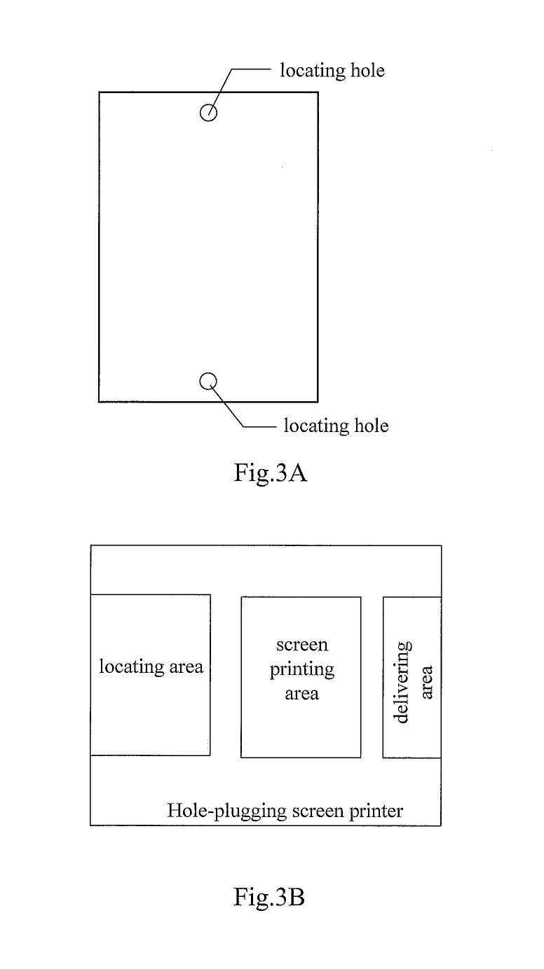

According to an example of the application, the locating device on the hole-plugging screen printer may be a charge coupled device (CCD). The size and number of the locating holes can be determined according to the resolution of the CCD locating device. For example, the radius or diameter of each locating hole may be 2.5 mm, or 2.7 mm, and so on. The number of the locating holes may be two or more. FIG. 3A shows a schematic view according to an example of the application, wherein two locating holes are drilled on a circuit board. As shown in FIG. 3A, each of the two locating holes is disposed adjacent to the corresponding width side of the circuit board. Preferably, the two locating holes are symmetrical relative to a center axis of the circuit board which is parallel to the width side. As such, the accuracy of alignment can be improved by disposing the locating holes symmetrically. It is understood by those skilled in the art that three or more locating holes can be disposed on the circuit board to improve the accuracy of alignment. Obviously, the more locating holes, the longer the time spent for alignment. Thereby, the number of the locating holes can be chose as according to specific requirement.

According to an example of the present application, the position of the locating device on the hole-plugging screen printer is adjustable, so as to adapt to the circuit boards with different shapes and different locating hole designs. However, when performing a hole-plugging process on a same batch of circuit boards with same shapes and same locating hole designs, the locating device can be fixed in a locked position on the hole-plugging screen printer by a locking device, such that each circuit board has approximately the same position and the same subsequent moving path after the position of the circuit board is adjusted according to the locating device. This contributes to the improvement of the consistency and processing efficiency of the hole-plugging process.

After the circuit board is transported to the screen printing area of the hole-plugging screen printer, the position of the hole-plugging stencil is adjusted by the hole-plugging screen printer according to the position of the circuit board to align the inking point on the hole-plugging stencil with the hole to be plugged on the circuit board, so as to let the ink on the hole-plugging stencil drop into the hole. The circuit board is located on the platform within the screen printing area of the hole-plugging screen printer. The spatial positional relationship among the platform of the hole-plugging screen printer, the circuit board and the hole-plugging stencil is as follows: the hole-plugging stencil is located in the top position, the circuit board is located in the middle position, the platform of the hole-plugging screen printer is located in the lower position, and the circuit board is located on the platform of the hole-plugging screen printer. In the step of adjusting the position of the hole-plugging stencil to align the inking point with the hole to be plugged on the circuit board, a method similar to above method using the locating device for alignment can be employed. According to an example of the application, another locating device can be disposed in the screen printing area. This locating device identifies the position of the inking point in the hole-plugging stencil, and determines whether the inking point is aligned with the hole to be plugged on the circuit board, then adjusts the position of the hole-plugging stencil according to the result of the determination. According to an example, such determining process can be realized by the following steps: identifying the position of the inking point of the hole-plugging stencil; detecting whether what under the inking point is a hole through the inking point; if so, determining that the inking point is aligned with the hole to be plugged on the circuit board, if not (i.e. what under the inking point is the circuit board, the hole-plugging screen printer or others), determining that the inking point is not aligned with the hole to be plugged. Such identifying process and determining process may aim at one or more inking points. It is understood that the more inking points at which the identifying/determining process aims, the higher accuracy of alignment will be achieved, and the longer time will be spent on the aligning process. The locating device may be a charge coupled device (CCD).

Besides, it is understood by those skilled in the art that the hole-plugging stencil needs to be drilled in a corresponding position in advance according to the position of the hole to be plugged on the circuit board when performing the hole-plugging process on the circuit board. The drilled position on the hole-plugging stencil is referred to as an inking point in the hole-plugging process.

FIG. 3B is a schematic view showing the position of each area of a hole-plugging screen printer according to an embodiment of the present application. As shown in FIG. 3, the locating area, the screen printing area, and the delivering area are in turn disposed on the platform of the hole-plugging screen printer. In the locating area, the locating device identifies the at least two locating holes, and the hole-plugging screen printer adjusts the position of the circuit board according to the result of identifying, so as to align the locating holes with reference marks on the locating device. The adjusted circuit board is transported to the screen printing area by a transporting device automatically. In the screen printing area, the hole-plugging screen printer adjusts the position of the hole-plugging stencil according to the position of the circuit board, and the circuit board is transported to the delivering area by the transporting device automatically after being hole-plugged. The circuit board is transported automatically from the delivering area to a subsequent device by a delivering device for further process.

According to the embodiment shown in FIG. 2, the circuit board is delivered from the delivering area to an oven. The oven automatically receives the circuit board delivered by the delivering device, and disposes it in the baking area of the oven for baking. According to an example of the application, the oven may be a tunnel oven. The tunnel oven can realize the automatic receiving and delivering of the circuit board.

The circuit board is delivered from the oven to a grinder automatically after being baked. The grinder grinds the circuit board after receiving it. The surface of the circuit board is flattened by grinding off the ink protruding on the surface of the circuit board.

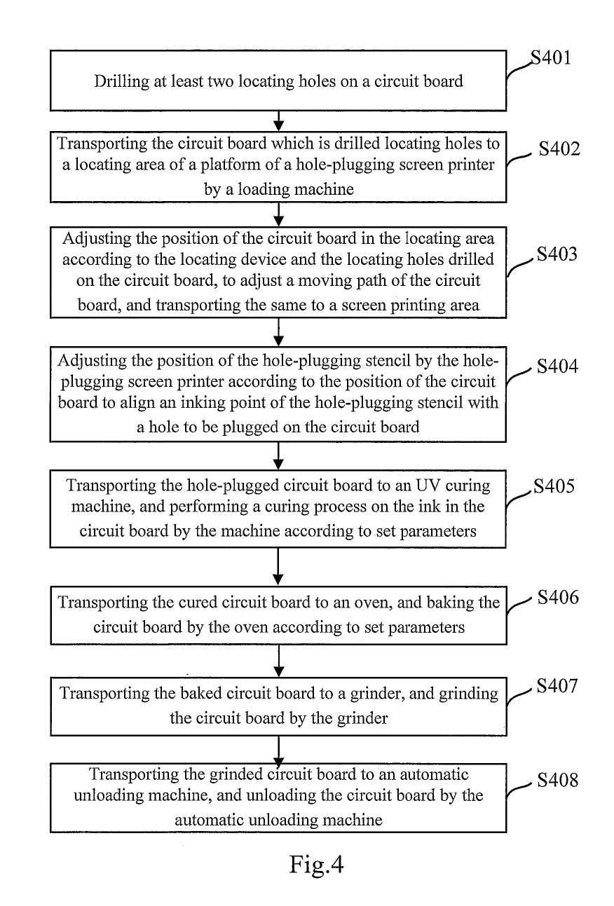

FIG. 4 is a flow chart of a method for performing a hole-plugging process on a circuit board according to an embodiment of the present application. The main difference between this embodiment and the embodiment shown in FIG. 2 is that the hole-plugged circuit board is delivered from the delivering area of the hole-plugging screen printer to an UV curing machine rather than an oven. In this embodiment, the hole-plugging ink may be photosensitive ink, such as ultraviolet (UV) thermosetting ink. The UV thermosetting ink will undergo polymerization reaction and be cured immediately under the UV light. Thereby, the ink can be preliminarily cured by using the UV curing machine before entering the oven, so as to improve the technological stability of the hole-plugging process.

As shown in FIG. 4, the circuit board is delivered from the delivering area to the UV curing machine. The UV curing machine automatically receives the circuit board delivered by the delivering device, and disposes the circuit board in a UV exposing and curing area. The UV curing machine performs a curing process on the ink in the circuit board according to set parameters (step S405). According to an example of the application, the UV curing machine is a belt-conveyer type UV curing machine, so as to realize the automatic receiving and transporting of the circuit board.

The UV thermosetting ink is in liquid state, and can be converted into solid state after being cured by the UV curing machine. During the curing process, an energy parameter for curing may be set according to specific requirements, e.g. to be 1500 mj/cm², and so on. Of cause, it can be set to other parameters as required.

The circuit board is delivered to an oven by the delivering device after being subjected to the UV curing process and the oven bakes the circuit board according to a set parameter (step S406).

In the UV curing process of the hole-plugging ink, only the surface of the ink plugged into the hole is cured, and the ink within the hole has not been cured completely. Therefore, the UV thermosetting ink within the hole needs to be baked by the oven to convert from B-stage into C-stage completely.

The parameter of the oven may include a baking time parameter and/or a temperature parameter. For example, for a circuit board having a thickness of 1.88 mm or less, the time parameter may be set to 30 min, and the temperature parameter may be set to 150□. For a circuit board having a thickness of more than 1.88 mm, the baking time may be set to more than 30 min.

The baked circuit board is delivered to a grinder and is grinded by the grinder (step S407). As the UV thermosetting ink in the baked circuit board has been cured completely, the ink protruding on the surface of the hole-plugged circuit board can be flattened by the grinder.

According to an example of the application, the grinder is a nine-shaft grinder, or other type of grinder with vitrified grinding wheel. When a nine-shaft grinder is used for grinding, its first three shafts are vitrified grinding wheels, and its last six shafts are non-woven fabric grinding wheels. The grinding parameter of the grinder can be set as required.

The grinded circuit board is delivered to an automatic unloading machine by the delivering device and unloaded by the automatic unloading machine (step S408).

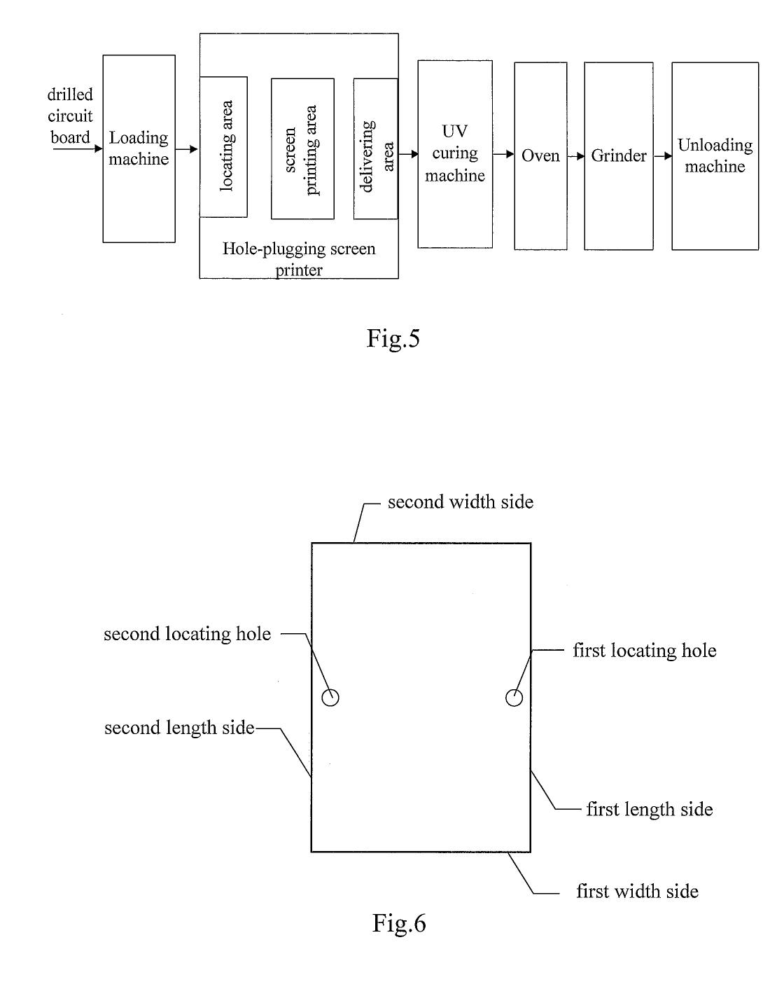

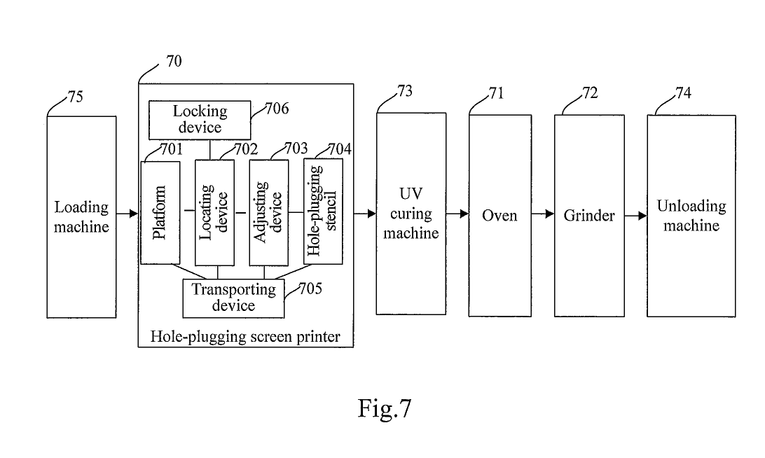

Each of FIG. 5 and FIG. 7 is a schematic block diagram of a system for performing a hole-plugging process on circuit board according to an embodiment of the present application. As shown, the system comprises a hole-plugging screen printer 70. The hole-plugging screen printer 70 may comprise a transporting device 705, a platform 701, a locating device 702, an adjusting device 703 and a hole-plugging stencil 704. The platform 701 is used to support the circuit board and comprises a locating area, a screen printing area and a delivering area. The hole-plugging screen printer 70 is provided to adjust a moving path of a circuit board at the locating area by the adjusting device 703 according the locating device 702 and at least two locating holes formed on the circuit board; and transport the circuit board to the screen printing area by the transporting device 705 according to the moving path, then adjust the hole-plugging stencil 704 by the adjusting device 703 to align an inking point on the hole-plugging stencil 704 with the hole to be plugged on the circuit board, so as to let the ink dropped from the inking point of the hole-plugging stencil 704 drop into the hole. The hole-plugging screen printer 70 may also comprise a locking device 706 used to lock the locating device 702 in a locked position.

The system may also comprise one or more of the following devices: an oven 71 for baking the hole-plugged circuit board; a grinder 72 for grinding the baked circuit board to grind off the ink protruding on the surface of the circuit board; an UV curing machine 73 for performing a UV curing process on the hole-plugged circuit board; a unloading machine 74 for unloading the grinded circuit board; a loading machine 75 for loading a circuit board and delivering the circuit board to the hole-plugging screen printer; and a delivering device for delivering the circuit board among each part of the system automatically.

The system can be used to execute above method for performing a hole-plugging process on a circuit board. The operation of the system can be known from the above explanation of the method, thus the description thereof is omitted.

A person of ordinary skill in the art may change or modify the described exemplary embodiment without departing from the scope of the present invention, and the change or modification are also included in the scope of the present invention.

1. A method for performing a hole-plugging process on a circuit board comprising:
forming at least two locating holes on the circuit board;
delivering the circuit board to a locating area of a hole-plugging screen printer, and adjusting a moving path of the circuit board in the locating area according to a locating device of the hole-plugging screen printer and the locating holes; and
transporting the circuit board to a screen printing area of the hole-plugging screen printer automatically according to the moving path, and adjusting a hole-plugging stencil of the hole-plugging screen printer to align an inking point of the hole-plugging stencil with a hole to be plugged on the circuit board, so as to plug ink dropped from the inking point of the hole-plugging stencil into the hole.

2. The method of claim 1, further comprising:
delivering the hole-plugged circuit board to an oven automatically and baking the circuit board; and
delivering the baked circuit board to a grinder automatically and grinding the circuit board to grind off ink protruding on a surface of the circuit board.

3. The method of claim 2, wherein the ink is UV thermosetting ink, and before the step of delivering the hole-plugged circuit board to an oven, the method further comprises:
delivering the hole-plugged circuit board to an UV curing machine automatically and performing an UV curing process on the ink in the circuit board.

4. The method of claim 1, wherein the step of adjusting a moving path of the circuit board according to a locating device of the hole-plugging screen printer and the locating holes comprises:
identifying the locating holes by the locating device, and adjusting the position of the circuit board by the hole-plugging screen printer according to the identifying result to align the locating holes with reference marks on the locating device.

5. The method of claim 4, wherein the locating device is a charge coupled device.

6. The method of claim 1, wherein before the step of adjusting the moving path of the circuit board, the method further comprises:
fixing the locating device in a locked position on the hole-plugging screen printer.

7. The method of claim 1, wherein the step of adjusting the circuit board and the step of adjusting the hole-plugging stencil of the hole-plugging screen printer are executed by the hole-plugging screen printer.

8. The method of claim 1, wherein the circuit board is automatically delivered to the locating area of the hole-plugging screen printer by a loading machine.

9. A system for performing a hole-plugging process on a circuit board comprising:
a hole-plugging screen printer comprising a transporting device, a platform, a locating device, an adjusting device and a hole-plugging stencil, wherein the platform is used to support the circuit board and comprises a locating area and a screen printing area,
wherein the hole-plugging screen printer is provided for
adjusting a moving path of a circuit board at the locating area by the adjusting device according to the locating device and at least two locating holes formed on the circuit board; and
transporting the circuit board to the screen printing area by the transporting device according to the moving path, and adjusting the hole-plugging stencil by the adjusting device to align an inking point on the hole-plugging stencil with the hole to be plugged on the circuit board, so as to plug ink dropped from the inking point of the hole-plugging stencil into the hole.

10. The system of claim 9, further comprising:
an oven for receiving the hole-plugged circuit board automatically and baking the circuit board; and
a grinder for receiving the baked circuit board automatically and grinding the circuit board to grind off ink protruding on a surface of the circuit board.

11. The system of claim 10, further comprising:
an UV curing machine for receiving the hole-plugged circuit board and performing an UV curing process on the ink in the circuit board and delivering the UV cured circuit board to the oven.

12. The system of claim 9, further comprising:
a locking device for fixing the locating device in a locked position on the hole-plugging screen printer.

13. The system of claim 9, wherein the locating device is a charge coupled device.

14. The system of claim 9, further comprising:
a loading machine for delivering the circuit board to the locating area of the hole-plugging screen printer.

15. The system of claim 11, further comprising:
a delivering device for delivering the circuit board among the hole-plugging screen printer, the UV curing machine, the oven, and/or the grinder of the system.

16-27. (canceled)
